(19) United States
(12) Patent Application Publication
(10) Pub. No.: US 2018/0242529 A1
(43) Pub. Date: Aug. 30, 2018

(54) Intelligent Container

(71) Applicants: BOE Technology Group Co., Ltd., Beijing (CN); Beijing BOE Optoelectronics Technology Co., Ltd., Beijing (CN)

(72) Inventors: Ting Tian, Beijing (CN); Jinge Zhao, Beijing (CN); Dayong Zhou, Beijing (CN); Shuqian Dou, Beijing (CN); Jinshan Liu, Beijing (CN); Ming Zhai, Beijing (CN); Liguang Deng, Beijing (CN); Tae Sung Kang, Beijing (CN); Hyungkyu Kim, Beijing (CN)

(73) Assignees: BOE Technology Group Co., Ltd., Beijing (CN); BOE Technology Group Co., Ltd., Beijing (CN); Beijing BOE Optoelectronics Technology Co., Ltd., Beijing (CN); Beijing BOE Optoelectronics Technology Co., Ltd., Beijing (CN)

(21) Appl. No.: 15/561,847

(22) PCT Filed: May 17, 2017
(86) PCT No.: PCT/CN2017/084693

§ 371 Date: Sep. 26, 2017

(30) Foreign Application Priority Data
Nov. 22, 2016 (CN) 201611028020.5

(51) Int. Cl. A01G 7/04; F21V 33/00; A01G 9/20; A01G 9/02; B44F 1/06

(52) U.S. Cl. CPC A01G 7/045; F21V 33/0028; F21Y 2115/10; A01G 9/02; B44F 1/06; A01G 9/20

(57) ABSTRACT

An intelligent container is provided. The container includes a body; and a light-emitting device disposed on the body. The light-emitting device includes at least one light-emitting unit, the light-emitting unit being configured to emit light towards the inside of the body and the outside of the body. The light-emitting unit of the intelligent container can emit light bidirectionally to provide a light source for a plant therein in the growth process of the plant, and simultaneously provide an illumination to the outside.

### TECHNICAL FIELD

At least one embodiment of the present disclosure relates to an intelligent container.

### BACKGROUND

With the improvement of life quality, people are in pursuit of better living environment. For instance, more and more people like to cultivate green plants or flowers in home or office. Plants have different requirements on illumination at different growth stages and even have different requirements on light of different colors. The illumination of indoor home plants is often difficult to meet the illumination requirement of plants such as light/sun-loving plants. Therefore, how to keep plants alive and beautiful is a bothering thing. If an additional device, such as an illumination device, is mounted for the indoor plants, additional indoor space will be occupied. In addition, the current container, for instance, a vase for cultivating plants, is used as an indoor ornament. As the container is only used as a container for cultivating plants and an indoor ornament, the container has simple function and is difficult to meet people's pursuit on simple and aesthetic life.

### SUMMARY

At least one embodiment of the present disclosure provides an intelligent container, comprising: a body; and a light-emitting device provided on the body, the light-emitting device including at least one light-emitting unit configured to emit light towards the inside and the outside of the body.

For example, in the intelligent container provided in at least one embodiment, the light emitted by the light-emitting unit includes at least one of red light, green light, blue light, or white light.

For example, in the intelligent container provided in at least one embodiment, the light-emitting unit includes a light-emitting diode (LED).

For example, in the intelligent container provided in at least one embodiment, the body is provided with a first opening; and the at least light-emitting unit is provided in the first opening.

For example, the intelligent container provided in at least one embodiment further comprises a base connected with the body and configured to support the body.

For example, the intelligent container provided in at least one embodiment further comprises a control unit provided on the base, the control unit being communicated with the light-emitting device to control the emission of the light-emitting device.

For example, in the intelligent container provided in at least one embodiment, the control unit is configured to control at least one of the intensity, or the color of the light-emitting device.

For example, the intelligent container provided in at least one embodiment further comprises a display screen provided on the body, the display being communicated with the control unit to respond to a transmission signal of the control unit and achieve a display.

For example, in the intelligent container provided in at least one embodiment, the display screen includes a flexible display screen, the flexible display screen including at least one of LCD screen, or OLED screen.

For example, in the intelligent container provided in at least one embodiment, the display screen includes a touch display screen.

For example, the intelligent container provided in at least one embodiment further comprises a sensor provided on the body, wherein the control unit is communicated with the sensor to receive a sensing signal sent by the sensor.

For example, in the intelligent container provided in at least one embodiment, the sensor includes at least one of a first sensing unit on the inside of the body, or a second sensing unit on the outside of the body.

For example, in the intelligent container provided in at least one embodiment, the first sensing unit is configured to detect at least one of a pH value, a salinity, or nutrient elements inside the body.

For example, in the intelligent container provided in at least one embodiment, the second sensing unit is configured to detect at least one of formaldehyde, dust or radioactivity outside the body.

For example, in the intelligent container provided in at least one embodiment, the body is provided with a second opening; and the first sensing unit is communicated with the control unit through the second opening.

For example, the intelligent container provided in at least one embodiment further comprises a wireless communication device provided on the base, wherein the control unit sends, or receives signals through the wireless communication device.

For example, the intelligent container provided in at least one embodiment further comprises a wireless terminal, the wireless terminal being configured to receive signals from, or send signals to the control unit through the wireless communication device.

For example, the intelligent container provided in at least one embodiment further comprises a power supply provided on the base, the control unit being communicated with the power supply to control the on, or off of the power supply.

For example, the intelligent container provided in at least one embodiment further comprises a decorative layer provided on an external surface of the body and circuit wirings arranged on the body, the decorative layer exposing the light-emitting device; and the circuit wirings being arranged between the body and the decorative layer.

### BRIEF DESCRIPTION OF THE DRAWINGS

In order to demonstrate clearly technical solutions of the embodiments of the present disclosure, the accompanying drawings in relevant embodiments of the present disclosure will be introduced briefly. It is apparent that the drawings may only relate to some embodiments of the disclosure and not intended to limit the present disclosure.

FIG. 1 is a schematic structural view of an intelligent container;

FIG. 2 is a schematic structural view of a bottle mouth part above an A-A line of the intelligent container as shown in FIG. 1; and

FIG. 3 is a schematic structural view of another intelligent container provided by the embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is apparent that the described embodiments are just a part but not all of the embodiments of the disclosure. Based on the described embodiments herein, those skilled in the art can obtain other embodiment(s), without any creative work, which shall be within the scope of the disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

How to design an intelligent container product, which provides illumination for the ambient environment and meanwhile provides illumination for the growth of plants according to the growth stage of the plants in the container, e.g., a vase, is a blank in the current relevant products. In the growth process, the plants have large illumination requirement and may also have different requirements on light of different colors at different growth stages. For instance, as for sun-loving plants, for instance, when the plants are placed in an environment absence of natural light, e.g., indoors, the plants cannot obtain sufficient light for the growth of the plants, resulting in poor plant growth and even withered state, and the appearance is affected. If corresponding illumination device is provided for the plants indoors, the cost is expensive and the space is occupied.

It should be noted that at least one embodiment of the present disclosure provides an intelligent container capable of solving the above technical problem. For the convenience of understanding, description is given to the specific structure and function of the intelligent container provided by at least one embodiment of the present disclosure by taking a vase for cultivating plants as an example. It should be understood by those skilled in the art that the intelligent container is not limited to the vase only used for cultivating the plants.

At least one embodiment of the present disclosure provides an intelligent container. The intelligent container includes a body and a light-emitting device disposed on the body. The light-emitting device includes at least one light-emitting unit. The light-emitting unit may emit light towards the inside and the outside of the body. The light emitting towards the inside of the body can meet the needs of plant growth, and the light emitting towards the outside of the body can provide illumination for the ambient environment.

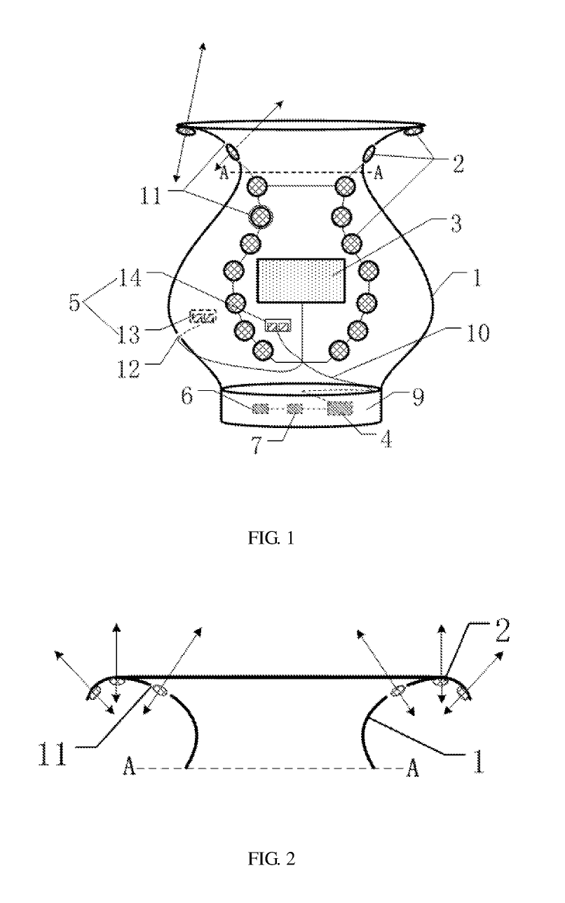

At least one embodiment of the present disclosure provides an intelligent container. FIG. 1 is a schematic structural view of the intelligent container. For instance, as shown in FIG. 1, the intelligent container comprises a body 1 and a light-emitting device disposed on the body 1. The light-emitting device includes at least one light-emitting unit 2 as shown in FIG. 1. The light-emitting unit 2 may emit light towards the inside and the outside of the body 1, namely the light-emitting unit 2 can emit light bidirectionally. In the embodiment as shown in FIG. 1, the light-emitting unit 2 may provide light for the inside of the body 1 and the top of a bottle mouth. For instance, when branches and leaves of a plant(s) cultivated in the body is/are disposed on the top of the bottle mouth, the light-emitting unit 2 can provide light for the branches and leaves of the plants, meanwhile it can also provide illumination for the ambient environment of the body 1. Although the light-emitting units 2 are arranged into the distribution state as shown in FIG. 1, it is understood that the light-emitting unit 2 may be disposed at any position on the body 1 as required. For instance, the specific arrangement position of the light-emitting unit 2 may be determined according to the specific shape of the body 1. The shape of the body 1 and the specific arrangement position of the light-emitting unit 2 are not limited in the embodiment of the present disclosure, as long as the light-emitting unit 2 can simultaneously emit light for the inside and the outside of the body 1.

The light-emitting units 2 disposed on the body 1, for instance, may be connected with each other through circuit wirings 10. The preparation materials of the circuit wirings 10, for instance, may include flexible conductive materials. For instance, the preparation materials of the circuit wirings may include transparent conductive materials. The transparent conductive materials, for instance, may include indium tin oxide (ITO), aluminum zinc oxide (AZO), nano silver wires, metal meshes, carbon nanotubes, or graphene.

For instance, in an intelligent container provided by at least one embodiment of the present disclosure, the type of the light emitted by the light-emitting unit may include at least one of red light, green light, blue light, white light, or the like. In addition to participating in the photosynthesis of the plants, the light, for instance, may be used as an external signal to affect the growth of the plants. For instance, the light may have an effect on the synthesis of plant hormones. The effect of the light on the plants includes many aspects, such as, seed germination, stem growth, leaf and root development, phototropism, synthesis of chlorophyll, branching and flower induction, promotion of stem and leaf development, or inhibition of lateral bud growth.

Light of different colors has different effects on a plant growth. For instance, red light is more effective in the aspects of inducing blossom, seed germination, stem and leaf growth, leaf shedding, tuberization, bud dormancy, or the like. For instance, the blue light is more effective in aspects of leaf stomata opening, delaying plant senescence, increasing protein content, synthesis of chlorophyll, increasing plant phototropism, or the like.

Different growth stages of plants have different requirements on the light of specific color. For instance, in at least one embodiment of the present disclosure, each light-emitting unit may independently emit light of red, blue, green, or the like, or the light-emitting unit may emit light of multiple colors and combine the light of different colors. For instance, the light-emitting unit may also control the intensity and the proportion of the emitted light of various colors.

For instance, in an intelligent container provided by at least one embodiment of the present disclosure, the light-emitting unit 2 may be a light-emitting diode (LED). For instance, the light-emitting unit may be an organic light-emitting diode (OLED). The LED may include a plurality of pixels. Each pixel, for instance, may include R, G, and B subpixels. The subpixels may emit lights of corresponding colors. In this way, each pixel may independently emit light of R, G, or B color, or a combination of the light of the three colors by controlling switching of each subpixel.

For instance, in at least one embodiment of the present disclosure, the light-emitting device may be designed to include at least two light-emitting units 2 in a manner of emitting light unidirectionally (e.g., OLEDs), respectively. Moreover, the light-emitting direction of at least one light-emitting unit 2 is towards the inside of the body 1; the light-emitting direction of at least one light-emitting unit 2 is towards the outside of the body 1; and each light-emitting unit 2 may be designed to operate independently. In this way, the light-emitting device may have multiple light-emitting modes, for instance, emitting light towards the inside of the body 1, emitting light towards the outside of the body 1, or simultaneously emitting light towards the inside and the outside of the body 1.

For instance, in an intelligent container provided by at least one embodiment of the present disclosure, the body 1 may be provided with an opening(s), for instance, a first opening(s), and the light-emitting unit(s) 2 may be disposed in the opening(s).

The intelligent container may adopt one, or a combination selected from a transparent state, a nontransparent state, or a semitransparent state. For instance, in at least one embodiment of the present disclosure, the intelligent container may be a transparent vase. For instance, the body of the intelligent container may include a transparent material, such as transparent glass; the light-emitting unit(s) is/are, for instance, disposed on an external surface of the body; and the light emitted by the light-emitting units may illuminate the plants through the body. For instance, in at least one embodiment of the present disclosure, the intelligent container may be in a nontransparent state. For instance, the body of the intelligent container may include a nontransparent material, such as ceramic. The light-emitting unit(s) may be, for instance, disposed in the opening(s) (e.g., the first openings 11 in FIG. 1) embedded on the body. In this way, the light-emitting units may simultaneously emit light towards the inside and the outside of the body of the intelligent container.

It should be noted that the sectional shape of the opening (e.g., the first openings 11, the second openings 12, or the like in the following embodiments) on the body 1 is not limited in the embodiments of the present disclosure. For instance, the sectional shape of the openings may include circular, rectangular, polygonal, or the like.

For instance, in at least one embodiment of the present disclosure, as shown in FIG. 1, the light-emitting units 2 disposed on the body 1 of the intelligent container are not limited to be disposed at the bottle mouth to provide light for branches and leaves on the top of the body 1, and they may be disposed at any position of the body 1. For instance, the intelligent container is not limited to only cultivate flower plants and is applicable to any container in which a light source need to be provided for the inside and the outside of a container body, for instance. For instance, the body 1 may also be a micro-landscape ecological tank, and the plants in the body are small plants, algae, or other sun-loving creatures. The light-emitting units 2 disposed, for instance, in the middle of the body 1 may provide a light source for creatures in the body.

For instance, in the intelligent container provided by at least one embodiment of the present disclosure, as shown in FIG. 1, the intelligent container may also include a base connected with the body 1 and configured to support the body 1. The base 9 and the body 1 may be an integral structure. The base 9 and the body 1 may also be freely assembled.

The base is not limited to a circular base as shown in FIG. 1. The shape of the base may be designed as needed. The position of the base 9 is not limited to be disposed below the body 1 as shown in FIG. 1, either, and it may also be disposed on one side of the body 1, or encircle the body 1, so that the base 9 can support the body 1. The specific structure and the arrangement position of the base 9 are not limited in the embodiment of the present disclosure.

For instance, in the intelligent container provided by at least one embodiment of the present disclosure, as shown in FIG. 1, a control unit 4 may be disposed on the base 9 of the intelligent container. The control unit 4 may be communicated with the light-emitting device through, for instance, circuit wirings 10, to control the emission of the light-emitting device(s). For instance, the control unit 4 may control the intensity, or the color combination of the light of the light-emitting units 2 in the light-emitting device. For instance, the light-emitting units 2 include a plurality of pixel units formed by at least three subpixels, respectively. Each subpixel may independently emit light of R, G, or B color. The control unit 4 drives the light-emitting units 2 of the light-emitting device to provide a light source for the plants according to, for instance, the requirements of different growth cycles of the plants on different lights (including light of specific color, a combination of light of various colors, or light intensity), by controlling the switching of each subpixel, or the intensity of the light emitted by the subpixel.

For instance, in at least one embodiment of the present disclosure, the control unit 4 may include a switching element, or the like. If a more complex control function needs to be achieved, a corresponding hardware circuit may also be provided to achieve corresponding function. The hardware circuit includes a conventional very large scale integrated (VLSI) circuit, or a gate array and a conventional semiconductor, such as logic chips, or transistors, or other discrete elements. For instance, the control unit 4 may also be implemented by a programmable hardware device, such as a field programmable gate array, a programmable array logic, or a programmable logic device.

For instance, in the intelligent container provided by at least one embodiment of the present disclosure, as shown in FIG. 1, the intelligent container may also comprise a display screen 3 disposed on the body 1. The display screen 3 is communicated with the control unit 4 to respond to a transmission signal of the control unit 4 and a displaying operation. For instance, the display screen 3 may be a flexible display screen and may be curved according to the shape of the body 1 and attached to the body 1. For instance, the display screen 3 is a liquid crystal display (LCD) screen, an OLED screen or an LED display screen. The display screen 3, for instance, may include a substrate, such as a glass substrate, a switching element, such as a thin-film transistor (TFT), a display layer, an encapsulated layer, and the like. For instance, the display screen 3 may be a touch display screen; the display screen 3 may be communicated with the control unit 4; and a data signal may be sent to the control unit 4 by touching the display screen, to adjust and control the control unit 4.

One example of the display screen is an LCD screen, which comprises an array substrate and an opposed substrate. The array substrate and the opposed substrate are arranged oppositely to form a liquid crystal cell, and liquid crystal materials are filled in the liquid crystal cell. The opposed substrate, for instance, is a color filter (CF) substrate. A pixel electrode of each pixel unit of the array substrate is used for applying an electric field to control the rotation degree of the liquid crystal materials and achieve a displaying operation.

Another example of the display screen is an OLED screen. A layer stack of organic light-emitting materials is formed on an array substrate of the OLED display screen; and a pixel electrode of each pixel unit is used as an anode and a cathode and configured to drive the organic light-emitting materials to emit light, to achieve a displaying operation.

Another example of the display screen is an e-paper display screen. An electronic ink layer is formed on an array substrate of the e-paper display screen; and a pixel electrode of each pixel unit is configured to apply a voltage for driving charged microparticles in an electronic ink to move, and perform a displaying operation.

For instance, in the intelligent container provided by at least one embodiment of the present disclosure, as shown in FIG. 1, the intelligent container may also comprise a sensor 5 disposed on the body 1. The control unit 4 is communicated with the sensor 5 to receive a sensing signal sent by the sensor 5.

A plurality of arrangement manners of the sensors 5 is provided. For instance, in at least one embodiment of the present disclosure, as shown in FIG. 1, the sensor 5 may include a first sensing unit 13 and a second sensing unit 14. The body 1 is provided with an opening (a second opening 12). The first sensing unit 13 is disposed in the body 1 and communicated with the control unit 4 through the second opening 12. For instance, the second sensing unit 14 is not limited to be disposed on the body and may also be disposed on the base 9.

Environmental factors, such as temperature, humidity, and nutrient content, will also affect the growth of the plants, so these factors need to be detected in real time for timely adjustment and control. For instance, in at least one embodiment of the present disclosure, the sensors 5 may detect multiple environmental parameters, such as temperature and humidity. For instance, the first sensing unit disposed in the body 1, may also, for instance, detect the pH value, the salinity, nutrient elements or the like in the body 1. The detected nutrient elements may include nitrogen, phosphorus, potassium, or the like. For instance, the second sensing unit disposed on the outside of the body may also detect environmental parameters of ambient, such as indoor, and the environmental parameters may include, for instance, formaldehyde, dust, radioactivity, or the like.

For instance, in at least one embodiment of the present disclosure, the sensor 5 may transmit the detected sensing signal to the display screen 3 through the control unit 4; the display screen 3 may display the information on the screen; and corresponding adjustment may be made according to, for instance, the plants' demand for various environmental factors. For instance, if the ambient humidity displayed on the display screen 3 is low and lower than the humidity required by, for instance, plant growth, the ambient humidity may be adjusted to be high, so as to help the plant growing. For instance, the control unit 4 may also include a storage unit. The storage unit includes different plants' demands for different factors, such as illumination, temperature and humidity, and mineral elements at different growth stages, and displays the information on the display screen so as to be compared with corresponding factors detected in real-time. For instance, the detected humidity in real-time is compared with the humidity actually required by corresponding plant growth, so as to direct the adjustment of the ambient environment, such as the temperature, and humidity. In this way, the intelligent container may provide better cultivation according to, for instance, different plants, or different growth periods of specific plant, so as to promote better growth of plants, for instance.

For instance, in the intelligent container provided by at least one embodiment of the present disclosure, as shown in FIG. 1, the intelligent container may also comprise a wireless communication device 6 disposed on the base 9. The control unit 4 sends, or receives signals through the wireless communication unit 6. For instance, the control unit 4 may send signals, for instance, relevant parameters detected by, for instance, the sensor 5, to an external wireless terminal through the wireless communication device 6, so as to achieve remote monitoring in real-time. For instance, the wireless communication device 6 may also be wirelessly communicated with the external wireless terminal, so that the control unit 4 can be controlled through the wireless communication device 6 by controlling the wireless terminal, and hence other structures communicated with the control unit 4 can be controlled. For instance, the switching state of the light-emitting units 2, and the emission state, such as light color, and light intensity, may be controlled, so as to achieve the remote control of the intelligent container. For instance, the wireless terminal may be a mobile phone, a computer, a tablet PC, or the like.

In order to ensure the safe growth of the plants, for instance, an alarm function may also be added. For instance, in at least one embodiment of the present disclosure, the intelligent container may also comprise an alarm unit. The alarm unit is communicated with the control unit. A safety threshold is set between a parameter (e.g., humidity) monitored in real time and a parameter (e.g., humidity) required by corresponding growth stage of the plants. An alarm information may be sent out when the factor parameter detected by relevant element, e.g., the sensor, of the intelligent container has a negative impact on plant growth, or the ambient environment, and the difference exceeds the safety threshold. The alarm information, for instance, may be that: an audible alarm system directly sends out an alarm to, for instance, people around. The alarm information, for instance, may be transmitted to the wireless terminal, such as a mobile phone, through the wireless communication device, so as to make relevant response in time.

For instance, in the intelligent container provided by at least one embodiment of the present disclosure, as shown in FIG. 1, the intelligent container may also comprise a power supply 7 disposed on the base 9. The control unit 4 is connected with the power supply 7 to control the on/off of the power supply 7. For instance, the power supply 7 may be an accumulator, or a socket power unit.

It should be noted that: in the embodiments of the present disclosure, the bottle mouth part of the intelligent container is not limited to be, for instance, a flat mouth structure as shown in FIG. 1, and may also be, for instance, an everted structure as shown in FIG. 2. FIG. 2 is a schematic structural view of the bottle mouth part above the A-A line of the intelligent container as shown in FIG. 1. When the structure of the bottle mouth is designed to be the everted structure as shown in FIG. 2, for instance, the light-emitting units 2 disposed at the edge of a flat mouth may expand, for instance, the illumination range for the plants in the container.

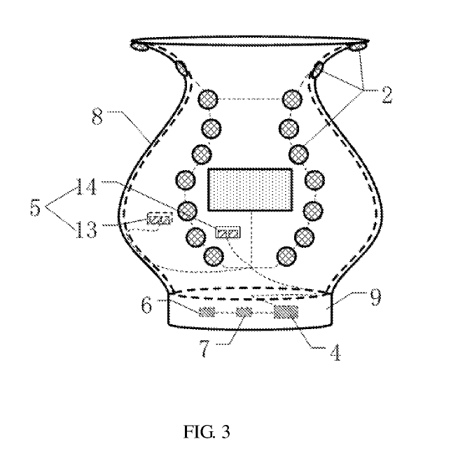

For instance, in the intelligent container provided by at least one embodiment of the present disclosure, FIG. 3 is a schematic structural view of another intelligent container provided by an embodiment of the present disclosure. As shown in FIG. 3, the intelligent container may also comprise a decorative layer disposed on an external surface of the body. The decorative layer exposes the light-emitting device. As shown in FIG. 3, a decorative layer 8 is disposed on an external surface of the body 1 (dotted lines represent the outline of the body). The decorative layer exposes, for instance, the light-emitting units 2 of the light-emitting device, the display screen 3, and the sensors 5 (the second sensing unit 14) disposed on the external surface of the body 1.

It should be noted that: in at least one embodiment of the present disclosure, the display screen 3 may be disposed on the decorative layer 8, or the display screen 3 is exposed by the decorative layer 8 by providing an opening in the decorative layer 8.

For instance, in the intelligent container provided by at least one embodiment of the present disclosure, as shown in FIG. 3, the intelligent container may also comprise circuit wirings 10 arranged on the body 1. The circuit wirings 10 are disposed between the body and the decorative layer and communicate the control unit 4 with, for instance, the plurality of light-emitting units 2 of the light-emitting device, the sensors 5, the display screen 3, the wireless communication device, and the power supply, and the like.

For instance, in at least one embodiment of the present disclosure, the circuit wirings may be disposed in an interlayer between the decorative layer and the body. For instance, the decorative layer is nontransparent and may be shielded by the decorative layer; or, the decorative layer may be a combination of a transparent material or nontransparent material. Nontransparent parts of the decorative layer formed by the nontransparent material may shield, for instance, the circuit wirings, and transparent parts of the decorative layer formed by the transparent material may allow people to see the environment in the body (e.g., a transparent body) from outside.

It should be noted that: in the embodiment of the present disclosure, the solid lines represent structures which can be intuitively viewed from the front view of the intelligent container, and the dotted lines represent, for instance, shielded structures which are included in the intelligent container but cannot be intuitively viewed. For instance, for the circuit wirings 10, for example, the circuit wirings 10 as shown in FIG. 1 disposed on the outside of the body 1 are represented by the solid lines, and those disposed on the inside of the body 1 are represented by the dotted lines (for instance, partial circuit wiring 10 connected with the first sensing unit 13 is represented by the dotted lines because they are disposed on the inside of the body 1). In the embodiment as shown in FIG. 3, as the decorative layer 8 is disposed on the external surface of the body 1, and the circuit wirings 10 disposed on the external surface of the body 1 are shielded by the decorative layer 8, these part of circuit wirings 10 are represented by the dotted lines in FIG. 3.

The following points should be noted:

(1) The accompanying drawings in the embodiments of the present disclosure only involve structures relevant to the embodiments of the present disclosure, and other structures may refer to the conventional design.

(2) For clarity, in the accompanying drawings of the embodiments of the present disclosure, the thickness of layers or regions is enlarged or reduced. That is, the accompanying drawings are not drawn according to actual scales.

(3) The embodiments of the present disclosure and the characteristics in the embodiments may be mutually combined without conflict.

The described above are only specific embodiments of the present disclosure, and the present disclosure is not limited thereto. The scope of the present disclosure is defined by the claims.

The application claims priority of the Chinese patent application No. 201611028020.5, filed on Nov. 22, 2016, the disclosure of which is incorporated herein by reference as part of the application.

1. An intelligent container, comprising:
a body; and
a light-emitting device provided on the body, the light-emitting device including at least one light-emitting unit configured to emit light towards the inside and the outside of the body.

2. The intelligent container according to claim 1, wherein the light emitted by the light-emitting unit includes at least one of red light, green light, blue light, or white light.

3. The intelligent container according to claim 2, wherein the light-emitting unit includes a light-emitting diode (LED).

4. The intelligent container according to claim 1, wherein the body is provided with a first opening; and the at least light-emitting unit is provided in the first opening.

5. The intelligent container according to claim 1, further comprising a base connected with the body and configured to support the body.

6. The intelligent container according to claim 5, further comprising a control unit provided on the base, wherein the control unit is communicated with the light-emitting device to control the emission of the light-emitting device.

7. The intelligent container according to claim 6, wherein
the control unit is configured to control at least one of the intensity, or the color of the light-emitting device.

8. The intelligent container according to claim 6 or 7, further comprising a display screen provided on the body, wherein the display screen is communicated with the control unit to respond to a transmission signal of the control unit and a displaying operation.

9. The intelligent container according to claim 8, wherein the display screen includes a flexible display screen.

10. The intelligent container according to claim 8, wherein the display screen includes a touch display screen.

11. The intelligent container according to claim 6, further comprising a sensor provided on the body, wherein the control unit is communicated with the sensor to receive a sensing signal sent by the sensor.

12. The intelligent container according to claim 11, wherein the sensor includes at least one of a first sensing unit on the inside of the body, or a second sensing unit on the outside of the body.

13. The intelligent container according to claim 12, wherein
the first sensing unit is configured to detect at least one of a pH value, a salinity, or nutrient elements inside the body.

14. The intelligent container according to claim 12, wherein
the second sensing unit is configured to detect at least one of formaldehyde, dust or radioactivity outside the body.

15. The intelligent container according to claim 12, wherein the body is provided with a second opening; and the first sensing unit is communicated with the control unit through the second opening.

16. The intelligent container according to claim 6, further comprising a wireless communication device provided on the base, wherein the control unit sends or receives signals through the wireless communication device.

17. The intelligent container according to claim 16, further comprising a wireless terminal, wherein the wireless terminal is configured to receive signals from, or send signals to the control unit through the wireless communication device.

18. The intelligent container according to claim 6, further comprising a power supply provided on the base, wherein the control unit is communicated with the power supply to control the on, or off of the power supply.

19. The intelligent container according to claim 1, further comprising a decorative layer provided on an external surface of the body and circuit wirings provided on the body, wherein the decorative layer exposes the light-emitting device; and the circuit wirings are arranged between the body and the decorative layer.

20. The intelligent container according to claim 2, wherein the body is provided with a first opening; and the at least light-emitting unit is provided in the first opening.
